(19) United States
(12) Patent Application Publication
(10) Pub. No.: US 2013/0117140 A1
(43) Pub. Date: May 9, 2013

(54) DATA TRANSPORT CONTENT ASSOCIATION

(71) Applicant: CELLCO PARTNERSHIP D/B/A VERIZON WIRELESS, Basking Ridge, NJ (US)

(72) Inventor: Nematolah KASHANIAN, Hackensack, NJ (US)

(73) Assignee: CELLCO PARTNERSHIP D/B/A VERIZON WIRELESS, Basking Ridge, NJ (US)

(21) Appl. No.: 13/724,540

(22) Filed: Dec. 21, 2012

Related U.S. Application Data
(63) Continuation-in-part of application No. 13/166,237, filed on Jun. 22, 2011.
(60) Provisional application No. 61/580,069, filed on Dec. 23, 2011.

(51) Int. Cl. H04L 29/08

(52) U.S. Cl. CPC H04L 67/02; G06Q 30/0601
USPC 705/26.1; 709/217

(57) ABSTRACT

A method is presented that enables the viewing of network data consumption from an alternative data plan (ADP) by a mobile device in terms of content. The method includes associating a mobile device, an application and content with an ADP and viewing data consumption in terms of content. A counter may be adjusted each time content associated with the ADP is consumed and the counter may be displayed on the mobile device which may also display data consumption in terms of megabytes (MB). The threshold size for the counter to increment may be preset per the rules of the ADP.

### RELATED APPLICATIONS

This application claims priority from U.S. Provisional Application Number 61/580,069, filed Dec. 23, 2011, and is a continuation-in-part of U.S. application Ser. No. 13/166.237, filed on Jun. 22, 2011, and entitled “Open Data Transport Bundle Marketplace Exchange,” the entire content of which are incorporated herein by reference.

### BACKGROUND

In recent years, consumer consumption of mobile data has rapidly increased with increased availability and popularity of mobile device(s). Advanced mobile device(s), such as mobile phones, provide a subscriber of a mobile service provider (e.g., Verizon Wireless™) with means to communicate with others using voice, SMS, electronic mail services, and a variety of multimedia and Internet data services. Mobile device(s) with Internet data service for example allow subscribers the ability to browse web pages. set-up wireless internet end points, use web applications, make purchases, and share information. Consequently, an increase in data consumption has increased the costs to network service providers due to high licensing fees and the need to build faster networks. Network service providers in turn have phased out unlimited data plans and replaced them with tiered data plans.

This increased access to the Internet and web-based applications has also increased interest from enterprises to create Internet enabled applications and browser based web applications for customers to use via mobile device(s). For example, recognizing that more and more users read newspapers on electronic devices, a newspaper publisher would like to partner with an electronic book reader (e-book reader) manufacturer to sponsor access to the Internet from e-book readers for downloading of the electronic version of the newspaper. Many users, however, pay for these services based on the amount of their data consumption in megabytes, which many users may find difficult to comprehend in terms of the discrete number of downloads/uploads completed.

Hence a need exists for providing mobile device users to view data usage in terms of content uploaded or downloaded over the network.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates exemplary processes for using a mobile data transport market exchange to develop an offer for a service to mobile device(s) end users.

FIG. 2 illustrates a mobile communication network as may be operated by a carrier or service provider.

FIG. 3 illustrates exemplary processes for creating a Data Transport Bundle.

FIG. 4 illustrates exemplary processes for creating an Alternative Data Plan.

FIG. 5 illustrates exemplary processes for purchasing an Alternative Data Plan

FIG. 6 illustrates exemplary processes for searching for an Alternative Data Plan

FIG. 7 illustrates exemplary processes for associating a content type with an Alternative Data Plan.

FIG. 8 illustrates exemplary processes for associating a content type with an Alternative Data Plan and determining the content size of uploaded content.

FIG. 9 is a simplified functional block diagram of a computer that may be configured as a host server, for example, to function as an ODME website host server.

FIG. 10 is a simplified functional diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

An aspect of this disclosure is a process that includes the steps of associating an alternative data plan (ADP) with a data transport bundle (DTB) for mobile data transport through a network. The ADP is configured for a service via a data market exchange of sufficient size to provide at least the amount of data transport required by the ADP. The method includes the step of associating a mobile device, an application accessed by the mobile device, and a content type with the ADP. The application utilizes the data transport through the network under the ADP to perform functionality of the application. Furthermore. the method includes a step of determining if content being transferred by the associated mobile device is of the associated content type. Only when it is determined that content being transferred is of the associated content type, then the method includes determining whether an amount of the content being transferred has reached a preset threshold. If so, the method includes the step of changing a counter reflecting an aggregate number of content units transferred by the associated mobile device utilizing the ADP. If not, then the counter is not changed. The method also includes a step of determining the aggregate number of content units transferred by the mobile device and displaying the aggregate number of content units transferred by the mobile device as an indication of the usage by the mobile device of the ADP based on content consumption instead of or in addition to megabyte consumption.

The above method includes features such as: associating the ADP with a transfer of content to and from a website; associating multiple different content types with the ADP; defining the preset threshold for each content unit to be the same for each type of content, or different for at least two different content types. In addition, the above method includes features such as, displaying the aggregate number of content units transferred by the mobile device for each different content type on the mobile device; sending a network communication to the mobile device when the amount of data transport over the time duration of the ADP is reached and providing and option to purchase an additional ADP. Further features of the above method may include: restricting data transport by the associated mobile device when the amount of data transport over the time duration of the ADP has been reached and additional ADP has not been purchased.

Another aspect of this disclosure includes the steps of associating an alternative data plan (ADP) with a data transport bundle (DTB) for mobile data transport through a network. The ADP is configured for a service via a data market exchange of sufficient size to provide at least the amount of data transport required by the ADP. The method includes the step of associating a mobile device, an application accessed by the mobile device, and a content type with the ADP. The application utilizes the data transport through the network under the ADP to perform functionality of the application. Furthermore, the method includes a step of determining if content being transferred by the associated mobile device is of the associated content type. Only when it is determined that content being transferred is of the associated content type, then the method includes. If so, the method includes the step of changing a counter reflecting an aggregate number of content units transferred by the associated mobile device utilizing the ADP. If not, then the counter is not changed. The method also includes a step of determining the aggregate number of content units transferred by the mobile device and displaying the aggregate number of content units transferred by the mobile device as an indication of the usage by the mobile device of the ADP based on content consumption instead of or in addition to megabyte consumption.

The above method includes features such as: associating the ADP with a transfer of content to and from a website; providing a network communication to the mobile device prior to transferring data; providing a network communication to the mobile device to abort the data transfer prior to processing the data transfer; not incrementing the counter when data transfer is aborted. Further features of the above method may include: sending a network communication to the mobile device when the amount of data transport over a time duration of the ADP is reached; the network communication comprises an option of purchasing an additional ADP; restricting data transport by the associated mobile device when the amount of data transport over the time duration of the ADP is reached and additional ADP has not been purchased; and associating multiple different content types with the ADP.

As used herein, the term “enterprise” means any organization created for business ventures. As used herein, the term “data transport bundle” (“DTB”, “DTBs” plural) means a module of data transport services purchased by an enterprise from a network service provider. In the examples, the components that make up such a DTB include the number of transactions, the amount (in MB) of data used, over a period of time and the cost per MB. A DTB can also include other components, such as: overage charges. eligible company type. effective date, end date, speed throttling, quality of service, private networking (VPN), international roaming, off peak and roll over. As used herein, the term “data transport of the DTB” means the component in the DTB that is the amount of data per period of time. The data transport of multiple DTBs may be combined to form a combined data transport component or partitioned and split to form new smaller DTBs and then recombined. As used herein, the term “alternative data plan” (“ADP”) means any data transport package that is an alternative to a billing agreement between a network provider and an existing or new network subscriber for use of data. As used herein, the term “entity” means one or more enterprises that offer the ADP to end users. As used herein, the term “speed throttling” means dynamically implementing network measures that will cap or limit users maximum bandwidth speeds on connections based on predetermined policies and thresholds. As used herein, the term “Quality of Service (QoS)” is a measure of performance that includes the speed of the data flow. QoS may accord various levels of guaranteed performance and different priorities dependent on, for example, application being used, user, data flows, or the type of network technology (1x, 3G, 4G, Wi-Fi). As used herein, the term “Private Network (VPN)” is a type of computer networking--typically using the public internet--that allows users to privately share information between remote locations, or between a remote location and a business' home network. A VPN can provide secure information transport by authenticating users, and encrypting data to prevent unauthorized persons from reading the information transmitted. As used herein, the term “International Roaming” means the extension of network connectivity service in an International location that is different from the home location where the service was registered and which the user's network is not the owner of the network. As used herein. the term “Off Peak” means the period when data usage is expected to be transmitted for a sustained period at a significantly lower than average supply level. As used herein, the term “Roll Over” means the ability to move or “roll over” data not utilized in a period paid for to another period.

The various examples disclosed herein relate to systems and processes enabling an enterprise or enterprises participating in a mobile data transport market exchange to associate content type with an alternative data plan and to display to a user the usage of the ADP based on the consumption of content instead of or in addition to megabyte consumption. This is accomplished by associating a user's device as well as an application on the device and a content type with the alternative data plan (ADP). The application on the device utilizes the ADP to perform functionality of the application. The ADP is then associated with a DTB or sufficient size to provide the amount of data transport required by the ADP. As used herein, the term DTB means a data plan purchased by an enterprise from a mobile network provider, the data transport of which can be combined with the data transport of other DTBs, either owned by the same enterprise or other enterprises. Based on the agreement between the enterprise and the mobile network provider, the DTB may be limited by the number of transactions, duration, megabyte usage, and/or cost per MB. When a user uploads to or downloads content from the associated device of the type that has been associated with the ADP, then a server receives indication of this and a counter stored in the server is incremented to reflect an aggregate number of contents uploaded or downloaded by the user via the ADP. The counter as stored on the server is then displayed on the device. Reference now is made in detail to the examples illustrated in the accompanying drawings and discussed below.

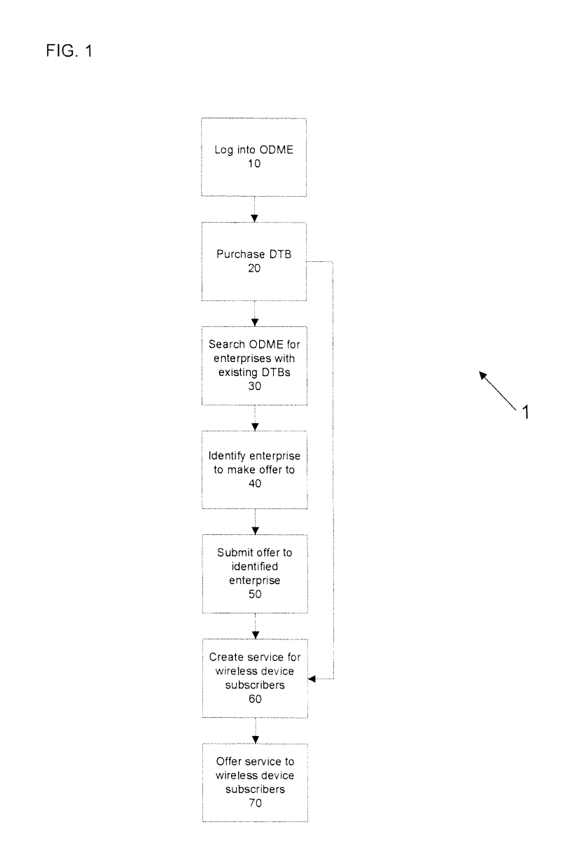

FIG. 1 illustrates an exemplary process for enabling an enterprise to identify another enterprise or multiple other enterprises with which to exchange proposals to create a service, such as an ADP, utilizing the transport service of multiple DTBs, for subscribers of a mobile network. In addition, FIG. 1 illustrates an exemplary process for enabling an enterprise to create an ADP from one or more purchased DTBs.

Referring to FIG. 1, the process begins with a representative of the enterprise logging in to access the Open Data Marketplace Exchange (ODME) web portal (Step 10). The representative accesses the ODME web portal via an Internet connection on a terminal. Examples of such a terminal include a computer having access to the Internet or a mobile device(s) having access to a wireless network that connects to the Internet. In order to maintain the security of the ODME transactions, a representative of each enterprise registers and is verified via a secure token. A user name and password may serve as the secure token that the ODME uses to verify the enterprise itself and that the representative of the enterprise is permitted to access the ODME web portal and make purchases of data transport bundles. Other forms of verification can also be used, such as a credit check of the user. Once the enterprise and representative are verified the representative can create users in the platform and designate them to purchase data, to share data, partition data and submit, accept or reject proposals.

The representative initially registers the enterprise with ODME by submitting information regarding the enterprise and the one or more representatives to the ODME. This information may include the name of the company, address, phone number. and financial information, or bank account number associated with the enterprise or representative, other financial information used for credit verification, as well as the role of the representative in the enterprise (e.g., Chief Technology Officer, Vice President of Marketing). In addition, information on the enterprise may include the types of services the enterprise provides, budget for wireless data purchases and any other information requested by the mobile network provider. The ODME processes the financial information or bank account number with the financial institution or bank in order to verify the identity of the enterprise and/or representative.

During initial registration, the information submitted by the representative is stored by the ODME in the ODME database, which associates the information with the enterprise and representative. The ODME then provides any terms of use of the ODME. which the representative must agree to on behalf of the enterprise in order to use the ODME. The representative is then asked to submit a unique login name and password to use to login into the ODME in the future. The ODME completes the registration process for the enterprise by storing the login information in the ODME database, associating the login information with the enterprise and representative and creating an ODME account number for the registered enterprise. Future transactions related to DTB purchases by the registered enterprise are stored on the ODME database and associated with the enterprise and the ODME account number.

The ODME account for the newly registered enterprise is associated with a messaging account, which the enterprise uses to send. receive, and view messages from the ODME and other enterprises participating in the ODME.

A representative of the enterprise subsequently logs onto the ODME website (step 10) by entering the secure token login information, such as the user name and password provided as above, into an input portion of the ODME website. The inputted identifying information is submitted to the ODME website host server and relayed to the ODME database server to verify the identity of the enterprise and access the enterprise ODME account. The enterprise may then access any messages sent via the ODME website by other enterprises. Such messages may include proposals from other enterprises to combine DTBs.

In a process 1 illustrated in FIG. 1, an enterprise purchases a DTB from the mobile network provider (Step 20). In one example, the mobile network provider sets a predetermined minimum and maximum data size (MB) range and number of DTBs that an enterprise is allowed to purchase via the ODME website. The mobile network provider may set these limits based on the enterprise's financial profile. The enterprise is able to view available DTBs that are within the predetermined range via the ODME web portal and that the owner of the DTB makes viewable to other enterprises using the ODME. Those DTBs not within the predetermined range may not be viewable by the enterprise.

This range is determined by the network provider, in part, by the credit score assigned by the network to the enterprise and associated with the enterprise account number and stored in the ODME database. The system may offer the network the ability to assign different enterprises with varying credit levels based on predetermined factors. These predetermined factors may include, for example: the earnings of the enterprise, DTB purchase history, current DTB ownership, and other financial information of the enterprise. This information is provided to the ODME by a representative of the enterprise during initial registration, discussed above, or submitted to the ODME upon request by the ODME, prior to purchase of a DTB. The information is stored in the ODME database and associated with the enterprise account number.

In addition to allowing an enterprise to view and purchase a DTB that is available for viewing and purchase by other enterprise, the network provider may also create a DTB for a specific enterprise. In this case, only that enterprise can view and agree to purchase the DTB using the ODME web portal.

The ODME in the above example enable the enterprise and the mobile network provider to exchange communications, e.g., offer and acceptance of an offer, to complete a commercial transaction relating to the purchase of a DTB. For example, a representative of the enterprise may log onto the ODME as described above, and view all available DTBs offered by the mobile network to the enterprise. The representative of the enterprise may then select one of the DTBs offered for purchase using the ODME web portal and purchase the DTB.

Alternatively, a periodic payment schedule may be set up via the ODME website in which an enterprise is charged for the DTB on a periodic basis. The mobile network provider may also include an overage charge if the amount of data in MBs (Z) in the DTB is exceeded. This overage charge may be assessed at a standard rate or be dependent on the original DTB purchase. In other embodiments, rather than acting as a purveyor of DTBs, the ODME website may support other purchase procedures, e.g., where the mobile network service provider advertises or makes the initial offer in response to a more general query from the enterprise. The composition of the DTB (amount of data, duration, number of transactions. cost) and other details about the DTB may be stored in the ODME server and associated with the enterprise account.

Once the DTB has been purchased, the enterprise can partition the data transport component of the DTB for different uses. For example, if the purchased DTB comprises 5 MB of data for 30 days for a total of 150 MB, the enterprise can partition half, or 75 MB, for consumption by employees of the enterprise and 75 MB to be associated with an ADP for resale to network subscribers (Step 60). The enterprise provides the details of how the data transport is to be partitioned to the network provider via the ODME website. These details are stored in the ODME server and consumption of the data transport from the DTB is monitored and stored in the ODME server. This is done when an enterprise creates an ADP. The creation of the ADP indicates that the enterprise is taking the purchased DTB and associating it to a device, URL, web site, etc., for a cost or for free.

For example, in order for employees of the enterprise to consume that portion of data transport of the purchased DTB that has been partitioned and designated for employee use, the enterprise associates employee devices that are to consume the portion of the data transport bundle with identifying information, such as IP addresses of the employee devices. The association may take place at the ODME server. The device identifying information is then provided to the ODME by the enterprise and stored in the ODME server. These designated users/devices are now associated with the partitioned employee portion of purchased DTB and stored in the ODME server. Individual device and user and total use of the data transport from the DTB by these designated users is stored in the ODME server and use information is accessed for viewing by one or more verified representatives of the enterprise.

In addition, according to this example, network subscribers who have purchased an ADP from the enterprise may consume the portion of data transport of the purchased DTB that has been partitioned and designated for the ADP use. Each ADP is associated with a single DTB. In order to use the DTB of the purchased ADP, the enterprise activates and provisions a device to that ADP via a network service provided based on provisioning API. The provisioning can be done for the user by the enterprise or the device can be provisioned by the user through the enterprise via a mobile device, mobile web, or desktop web site. The ADP is associated with a device's MDN (or other unique identifier) at the ODME server.

These ADP users are now associated with the partitioned ADP user portion of the purchased DTB and stored in the ODME server. The individual and total use of the data transport from the DTB by these ADP users is stored in the ODME server and use information is accessed for viewing by one or more verified representatives of the enterprise.

Once the enterprise has purchased the DTB from the mobile network provider, the information regarding the purchased DTB, any ADP associated with the DTB and the enterprise are stored on the ODME database server. The size, duration and transaction components of the purchased DTB as well as details about any ADP associated with the DTB may be available for viewing on the ODME website by other ODME enterprises and the network, although the cost of the DTB may not be available to other ODME users for viewing. The enterprise can explicitly agree to make its purchase viewable to authorized enterprises and restrict which enterprises can and cannot view the purchased DTB and any associated ADP based on criteria such as the primary type of business of the viewing enterprise (for example, the type of business that generates the most revenue for the enterprise, or what the enterprise is known to do, or the business segment of enterprise, for example, healthcare, entertainment, finance, media), target demographic of the enterprise or device type or application type. These restrictions are made using the ODME website. For example the enterprise that owns the DTB may not want competitors engaged in the same business from viewing the purchase of the DTB and any associated ADP and/or only want enterprises located in the same city from viewing the purchased DTB and any associated ADP or, if the enterprise forms a partnership with another enterprise, may grant authorization to see the traffic for the DTB only to the partner enterprise. These preferences may be submitted by a representative of the enterprise on a preferences section of the ODME web portal. These preferences of the enterprise are stored in the ODME database server and associated with the enterprise account. The ODME displays information on the enterprise in accordance with these settings.

Following the purchase of the DTB (Step 20), a representative of the enterprise in this example can use the ODME website to search the ODME database on the ODME database server for other enterprises participating in the ODME with existing DTBs (Step 30).

The search engine is hosted on the ODME database server and the search query is entered on a section of the ODME website. The search engine searches the ODME database for the search terms entered into the search engine and retrieves the results of the search in a list that is displayed on the ODME website to the representative.

For example, the enterprise searches the ODME database for other enterprises (Step 30) by including search terms about the various parameters of a DTB in which the enterprise is interested in combining with its purchased DTB. The search by the enterprise is submitted by a representative of the enterprise via an input device such as a keyboard on a terminal, such as a computer connected to the Internet that accesses the ODME website on the ODME website host server. The search terms are sent by the ODME website host server to the ODME database server on which all information submitted by representatives of other enterprises about these about these other enterprises is stored. The database search identifies all enterprises matching the search terms inputted by the enterprise in the ODME search.

Result data indicating all enterprises and DTB requests matching the inputted search terms is sent to the enterprise, for example, in a list of search results. These search results may be displayed to the enterprise via a page of the ODME website or sent via electronic mail or another means to the enterprise. The enterprise may narrow or broaden the ODME search by adding or removing search terms and sort the results by various search terms such as time or size. In reviewing the search results, the representative of the enterprise identifies enterprises to whom to submit an offer to combine DTBs (step 40).

The ODME also allows the enterprise to submit an offer/proposal to the identified enterprise(s) (Step 50). This is accomplished by sending a secure message to the identified enterprise(s) via the ODME website that is viewable by the identified enterprise(s) when the identified enterprise(s) logs onto the ODME. Multiple offers of one or more types may be submitted at the same time. The enterprise may include time limits within which the offers may be accepted.

In one example, a proposal may be for combining all or a part of the enterprise DTB with all or part of another DTB owned by the identified enterprise, and/or exchanging ideas on how to use the combined DTBs. The proposal is submitted via the ODME website to the identified enterprise(s) who may receive the proposal via an electronic message sent by the enterprise to the identified enterprise(s) via the ODME website (step 50). The enterprises may then communicate and exchange proposal-related ideas via the ODME.

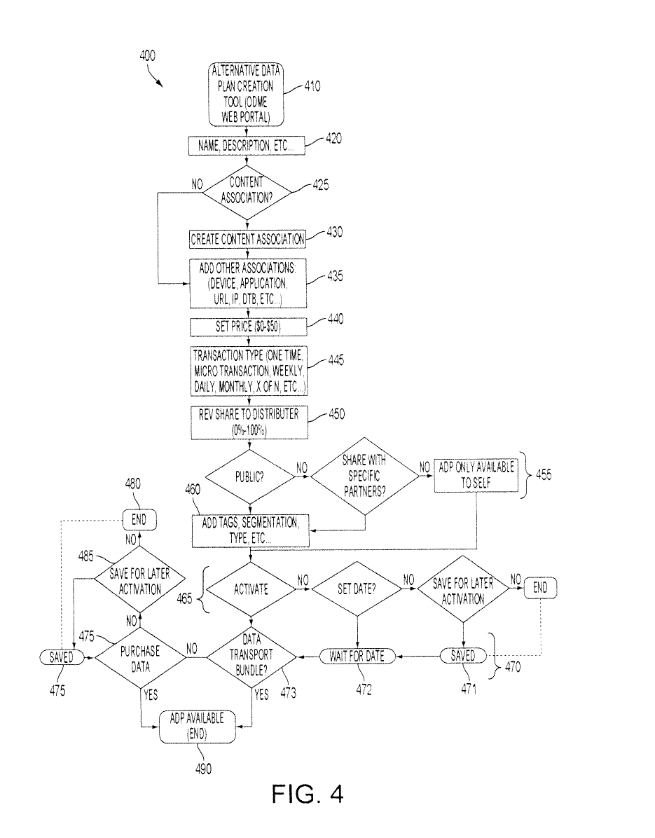

The ODME enables multiple enterprises to exchange communications. e.g., offer and acceptance of offers, to complete a commercial transaction relating to the combining and/or usage of a DTB. Once the enterprises have agreed on the manner in which to use the combined DTBs (owned by each of the enterprises), the enterprises can create an ADP subscriber service (Step 60) for network subscribers who consume the DTB(s). As defined above, an ADP means any data transport package that is an alternative to a billing agreement between a network provider and an existing or new network subscriber for use of data. Alternatively, an enterprise which has purchased a DTB may create an ADP directly with searching for and combining DTBS with other enterprises. An ADP is shown in FIG. 4, which is described in detail below.

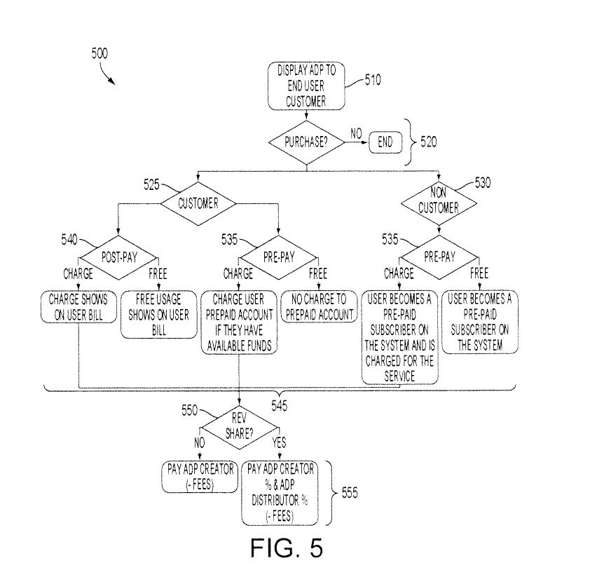

An agreement on how any revenues generated by the ADP service for the network subscribers are to be distributed may be determined prior to creation of the ADP subscriber service via an exchange of communications between the enterprises that may occur via the exchange of messages via the ODME. One or more of the enterprises may serve as the entity that offers the newly created ADP to end users. The ADP may be offered to network subscribers (step 70) by an entity formed by, associated with, and/or representing one or more of the enterprises. This offer of an ADP to network subscribers is shown in FIG. 5, which is described in detail below.

For example, an e-book reader enterprise and a newspaper publisher each purchase a DTB of 1 GB and then agree to combine their 1 GBs together into a 2 GB DTB. The e-book reader enterprise then makes an ADP with the 2 GB and associates it with their device and the newspaper web site. This allows users of the e-reader device to view the newspaper web site without it decrementing from their normal network provider based data plan. In this example, the user may not be a subscriber of the network.

The entity formed by, associated with, and/or representing one or more of the enterprises controls distribution of the ADP subscriber service and selects how the subscriber is billed for use of the ADP subscriber service. When the network provider bills the subscriber, the ODME collects payments by the subscriber for the ADP (less any transaction fees associated with putting this on the subscriber's bill) and passes on the payments to the enterprise that owns the ADP. The enterprise that owns the DTB may then share any profits generated from the ADP as collected by the network provider with other enterprises according to the terms of the agreed upon ADP offer. Alternatively, enterprise may charge the subscriber directly.

As previously discussed, once the ADP subscriber service is established and purchased, it may be activated by a subscriber after the entity provides the subscriber with an access code or other identifier unique to that subscriber. The entity may provide a list of identifiers associated with different ADPs associated with the subscriber service to the network provider via a terminal, via the Internet and the ODME website and this information may be stored on the ODME database server and associated with the DTB.

The subscriber may activate the service using a user device having a wireless connection that is able to connect to the mobile traffic network. In turn, the mobile traffic network may access information on the ODME database server or another network element, such as a mobile wallet that stores information from the ODME via the private network. The private network may receive information stored on the ODME database server to verify the unique identifier and associate the ADP created by the entity to the subscriber account and/or the enterprise account number via the mobile network subscriber server.

The consumption of data according to the rules of the subscriber service is monitored and data consumption records are stored by the network provider in the ODME database server or other server. Each use of the DTB under the rules of the ADP subscriber service may be provided to the entity via the ODME website. Any use of data by subscribers using the subscriber service that is in addition to the amount of data in the DTB may be charged to the entity or to the subscriber. Warnings may be provided to the entity at predetermined intervals when the total amount of data transport being used by subscribers using the ADP subscriber service is close to the maximum amount of data allowable in the DTB.

The ODME may send such warnings to the enterprises that have purchased the DTBs via the ODME as e-mails and/or internal messages. For example, if an enterprise purchases a DTB of 100 GB a month for a 3 month period, this means the enterprise can consume 100 GB in each month before overages are reached or the end customers can no longer access the service. If the enterprise has 100,000 users accessing a photo upload service each day, in month number two on the 20^{th} day the enterprise may receive a notification from the network via the ODME that the entity has consumed 75 GB of their 100 GB monthly allotment. The enterprise can then choose to buy an extra DTB, reset the warning for closer to the allotment or allow it to go into overage if the enterprise so desires. The enterprise may charge subscribers using the ADP that have exceeded the amount of data permitted. Alternatively, the entity may submit a request to the network provider via the ODME website to restrict the data use of the subscribers, or implement an alternative manner in which to charge a subscriber overage fees.

In addition, multiple network providers and network technologies may offer services via the ODME. Participants of the ODME can view DTBs offered by multiple network providers and can combine DTBs purchased from different network providers to create an ADP service.

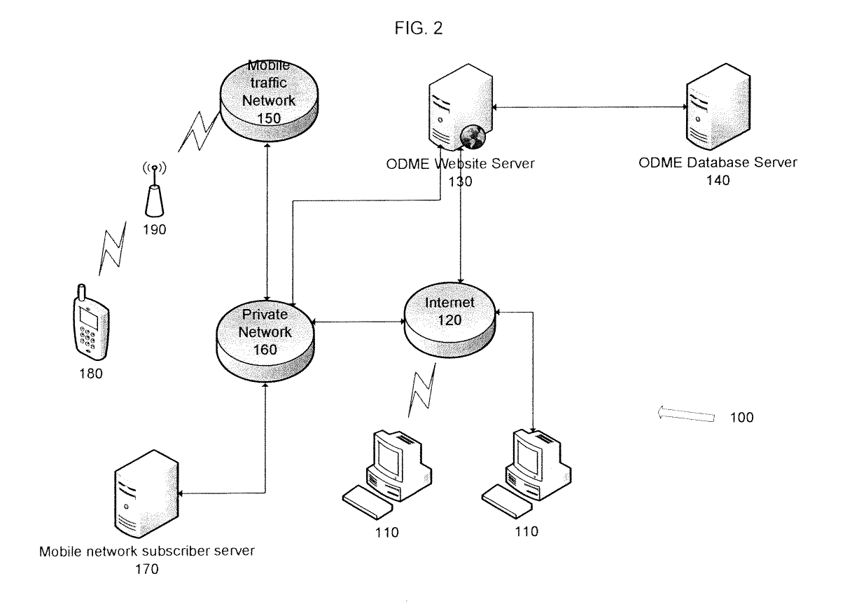

FIG. 2 illustrates an exemplary mobile communication network 100 operated by the network provider. Subscribers of the mobile network 100 may access the Internet 120 using the mobile device(s) 180 via base stations 190. The base stations 190 communicate with the mobile traffic network 150, which in turn communicates with the private network 160.

Although not separately shown, such a base station 190 typically comprises a base transceiver system (“BTS”). The BTS communicates via an antennae system at the site of base station 190 and over the air and link with one or more of the mobile device(s) 180 that are within range. Each base station typically includes a BTS coupled to several antennae mounted on a radio tower within a coverage area often referred to as a “cell.”

The BTS is the part of the radio network that sends and receives RF signals to/from the mobile device(s) that the base station currently serves. The mobile traffic network server 150 connects to a public packet switched data communication network, such as the network commonly referred to as the “Internet” shown at 120. Packet switched communications via the mobile traffic network 150 and the Internet 120 may support a variety of user services, such as mobile device(s) communications of text and multimedia messages, e-mail, web surfing or browsing, programming and media downloading. etc.

The enterprises in these examples search the ODME database on the ODME database server 140 via the website 130 for other enterprises participating in the ODME as discussed above in references to steps 30, 40 and 50. The search by the enterprise(s) is submitted via an input device such as a keyboard on a terminal, such as a computer 110 connected to the Internet 120 that access the ODME website on the ODME website host server 130. The search terms are sent by the ODME website host server 130 to the ODME database server 140 on which all information about all enterprises in the ODME resides to search the ODME database.

The database search identifies all enterprises and for any DTB or ADP requests matching the search terms inputted by the first enterprise in the ODME search. Result data indicating all enterprises and DTB requests matching the inputted search terms is sent to the respective enterprise(s), for example, in a list of search results. These search results may be displayed to the first enterprise via a page of the ODME website or sent via electronic mail or another means to the enterprise(s). The enterprise(s) may narrow or broaden the ODME search by adding or removing search terms.

Once the identified enterprise accepts the offer, the network provider is notified of any combing of DTBs as agreed upon by the enterprises. The combined DTB is partitioned by the network provider according to the terms of the agreed upon offer.

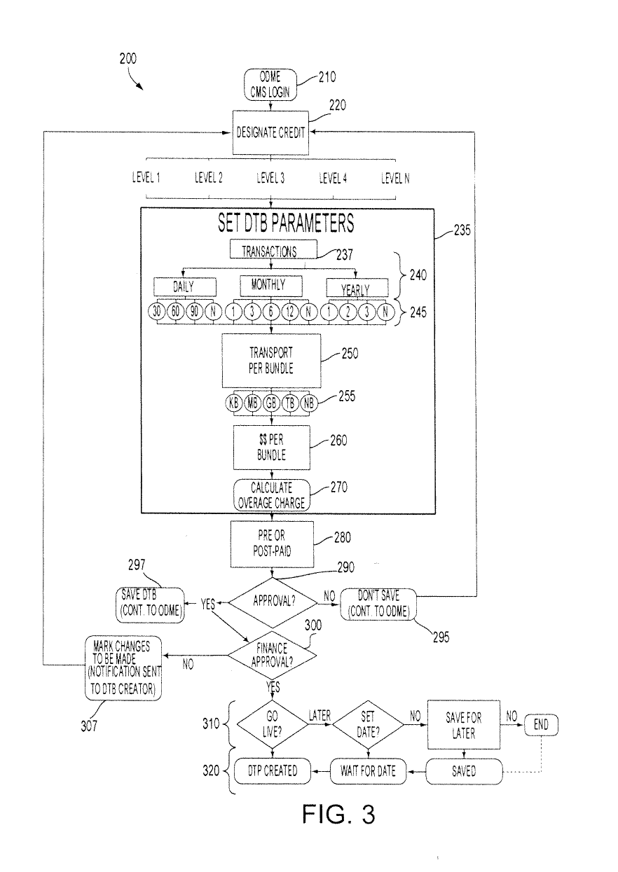

As shown in FIG. 3, in which a process 200 of a network service provider creating a DTB is illustrated, once a representative of an enterprise registers for the ODME and logs in at Step 210, the network designates a credit level to the enterprise at Step 220. Each credit level allows the enterprise access to view and purchase, via the ODME web portal, only those DTBs pre-determined by the network service provider to correspond to a particular credit level. For example, the network designates that a credit level of 1 allows access to DTBs of 1 TB or less, a credit level of 2 allows access to DTBs of 3 TB or less, a credit level of 3 allows access to DTBs of 5 TB or less, and a credit level of 4 allows access to DTBs of 9 TB or less. The network service provider can also determine which DTBs are available at certain credit levels based on other DTB components, in addition to or instead of the amount of data 255. The DTB components or parameters are set in 235, and include the number of transactions at Step 237, duration at Step 240, duration components at Step 245 (number of days, number of months, number of years), amount of data at Step 250, data units 255 (KB, MB, GB, TB, NB), cost per bundle at Step 260, and overage charges at Step 270. Once all of the DTB parameters have been set in 235, the DTB is created.

Payment for the purchase of the DTB may be made at the time it is purchased or paid for later at Step 280. In step 290, the created DTB is submitted to the network for approval. If the network approves the DTB, then the DTB is saved on the ODME server. If the network does not approve the DTB, the DTB is not saved and the process may restart from the step of the network designating the enterprise a credit level, 220. Following network approval any finance approval is requested at step 300. If financing is not approved, then the enterprise is notified that the purchase of the DTB has not been completed and can make changes to the DTB 307 and the process restarts at step 220. If financing is approved, the start date o for use of the DTB at Step 310 is then set. The DTB is then created at Step 320 at the appropriate start date. Steps 310 and 320 are similar to the steps after Step 460, below, and will be explained in more detail with regard to FIG. 4.

FIG. 4 shows an exemplary process 400 for creating an ADP. The exemplary process 400 begins with an entity accessing the ODME web portal and entering an ADP creation tool to create an ADP (Step 410). To create an ADP, the entity assigns a name and a description for the ADP (Step 420). The name and descriptions may be used to identify the ADP as well to inform the users of the nature and functionality of the ADP. For example, for uploading pictures, the description associated with an ADP may be the term “picture uploads.”

The entity may also wish to associate content with the ADP (Step 425). If so, the entity associates a particular content type with the created ADP (Step 430). For example, the ADP may be for accessing the web edition of a newspaper from an electronic tablet device. In this example, the website of the newspaper is associated with the ADP. When the user of the ADP attempts to access the newspaper from the user's electronic tablet, the network recognizes the website as being associated with the ADP and processes the request to access the website according to the rules of the ADP. For instance, the ADP may allow for free access to the newspaper website. If the entity does not wish to associate content type with the ADP, the process moves forward to Step 435. In Step 435, the entity associates other parameters with the ADP. The other parameters may include one or more devices, applications, URL, IP, and/or DTB. For example, the other parameters may include the newspaper website as described above, and a digital camera associated with the ADP which allows uploading of pictures.

The entity also sets the price associated with the ADP (Step 440). For example, the price may be from $0 to $50. The price of the ADP is further associated with a transaction type (Step 445). For example, the particular price may be for one time, daily, weekly, monthly, etc. uses. Based on the price and the transaction type, the customer utilizing the ADP pays the entity creating the ADP the set price. The entity may use part of the revenue from the usage of the ADP with the mobile communication network provider to pay for the created DTB (Step 450). When the transaction is set for one time, then the user may only use the ADP for a single transaction. Weekly, daily and monthly transactions allow for transactions of data on a once a week, once a day and once a month basis respectively. The ADP may also set the price for a micro transaction, i.e., a transaction subsequent to a first top-level transaction. For example, the entity may offer the download and viewing of an internet newspaper for free, however, the entity may charge for the viewing of the opinion section of the internet newspaper. In this example, the viewing of the opinion section of the internet newspaper is a micro transaction.

The availability of the ADP is then set in Step 455, which encompasses several individual steps. The availability of the ADP may be public (Step 451, Yes), or shared with specific partners of the entity (Step 452, Yes) or kept only to the enterprise itself (Step 454). An enterprise may make the ADP only available to itself in situations when it is not ready to activate the ADP or only wants to make the ADP available to employees of the enterprise. Once the availability of the ADP is set, tags are added to the ADP at Step 460.

Once the availability of the ADP is set and tags are added, the ADP may be activated at different points in time (Step 465). For example, the ADP can be activated right away (Step 466), in which case, the ADP is linked to one or more DTBs at Step 473 and if desired the enterprise may purchase more data at Step 475. If there is sufficient data for the ADP, the ADP is activated at Step 490. If it is determined at Step 485 that there is insufficient data for the ADP and additional data is not purchased, then the ADP may be saved for later activation (Step 495) or the ADP may be terminated (Step 480).

Alternatively, the ADP may be set for activation for an enterprise-set date in the future (Step 467), for example, in order to coincide with the sale of a particular product that will use the ADP. In this scenario, when the activation date arrives (Step 472), one or more DTBs are linked with the ADP (Step 473). If there is sufficient data available for the ADP, then the ADP is activated (Step 490). If additional data is needed, then additional data can be purchased at Step 475, as indicated above.

The ADP can also be saved for later activation (Step 468), for example, when a product that is anticipated to use the ADP is ready to be sold. In scenarios when the enterprise decides it does not wish to active the ADP, the activation step is ended (Step 469) and the ADP is saved (Step 471). The ADP may be saved on a server (Step 471), an activation start date for activation of the ADP is then awaited (Step 472), a DTB is associated with the ADP (Step 473) and if desired, a new DTB is purchased (Step 475).

As shown in FIG. 5, in which a process 500 for purchasing an ADP is illustrated, the ADP is displayed to a customer (Step 510) for purchase (Step 520). This display of the ADP (Step 510) may be done by including an offer of the ADP with a purchased product, such as a digital camera or electronic tablet. Alternatively the ADP offer may be sent to subscribers of a network via electronic mail. If the customer is a network subscriber (Step 525), the customer may pay for the ADP after use of the ADP has commenced, i.e., post-pay (Step 540). In this scenario, ADP charges are shown on the customer's bill (Step 541). In another scenario, the customer (who is a network subscriber) is given usage of the ADP for free, (Step 542) and this free or complimentary ADP service is shown on the network subscriber's bill. Alternatively, the customer (who again is a network subscriber) can pay for the ADP before ADP usage has commenced, i.e., pre-pay (Step 535A). In this scenario, the customer's account is charged for the ADP prior to ADP usage, if the customer's account has available funds (Step 543). Alternatively, the customer's pre-paid account may not be charged for the ADP (Step 537). The various ways in which a user is charged for use of the ADP are shown collectively as Step 545.

If the user is not already a network subscriber (Step 530), in the example shown in FIG. 5 the customer must pre-pay (Step 535B). In this scenario, the user pays the network provider in advance of the commencement of any ADP service (pre-pay) and thereby becomes a pre-paid subscriber on the system and is charged for the ADP service, the charges being deducted from the pre-paid amount (Step 538). Alternatively, a user who is not a network subscriber may set up a pre-pay account (Step 535) but receive the service for free. In this scenario, the user becomes a pre-paid subscriber on the system (Step 539).

Any prior revenue sharing between enterprise offering the ADP and/or the network is determined (Step 550) and revenue distribution is executed (Step 555). If revenue sharing is part of the ADP, then the ADP creator is paid a percentage of the revenue, as well as the distributor, less any fees. If the network collects revenues by billing the use, then the network acts as the distributor, distributing the revenue less any fees.

The following is a summary of exemplary scenarios creating an ADP: 1) A single enterprise purchases a DTB and creates an ADP for network subscribers; 2) A single enterprise purchases multiple DTBs from the same or different network providers and combines part or all of some or all of the data transport of the DTBs to create an ADP; 3) Multiple enterprises purchase DTBs from the same or different network providers and partition and combine the data transport of the respective DTBs to create an ADP.

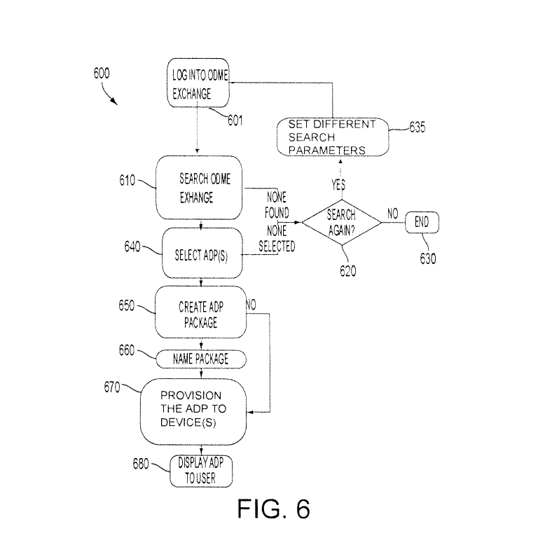

As shown in FIG. 6, in which a process 600 is shown for an enterprise to use the ODME web site to search the ODME exchange using an ODME search tool for participating enterprises with an existing ADP. The enterprise first logs into the ODME exchange (Step 601) and then searches the ODME exchange (Step 610) using a search engine of the ODME web site to enter search criteria that the enterprise is interested in finding in an existing ADP. For example, the enterprise enters the term “picture uploads” for an existing ADP that is for use by customers to upload pictures to a website. If the search engine returns no results for the entered search term(s), then the enterprise is asked if it would like to search again (Step 620). If the enterprise decides to search again, then the ODME may be searched by setting different search parameters 635. If the enterprise does not decide to search again, then the search ends, (Step 630). If an ADP or ADPs are found that match the entered search criteria, then the enterprise may select the matching ADP (Step 640), create an ADP package (Step 650), and optionally name the package, (Step 660). The API is used to provision the ADP to the device via the network platform (Step 670). The provisioning of the device may be done synchronously (i.e. at the same time the ADP package is created) or asynchronously (i.e. at a time later than when the ADP package is created). The ADP is then available to the user for display (Step 680) as described above.

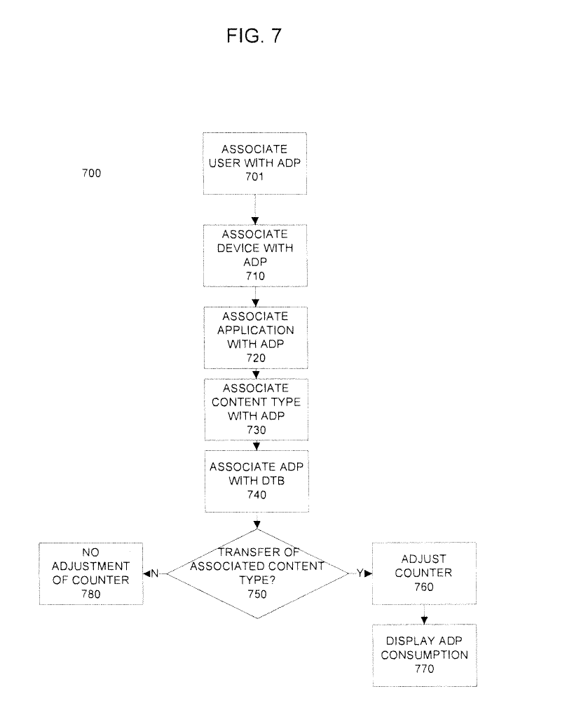

FIG. 7 shows a process 700 in which an ADP is associated with a DTB, mobile network user, mobile device, an application, and content type. First, an enterprise may associate a mobile network user (Step 701) and one or more mobile devices with the ADP (Step 710). The association of a user with the ADP in Step 701 may be in addition to or instead of the association of the ADP with a mobile device in Step 710. All associations with the ADP are stored in a network server, such as the ODME database server 140. If a user is associated with an ADP (Step 701) in addition to multiple mobile devices being associated with the ADP, then the terms of the ADP may allow different data transport rules depending on the type of ADP purchased by the user. For example, a premium plan may allow the user to associate an unlimited number of mobile devices with the ADP and consume data transport from the ADP with any of the associated mobile devices. Other ADP plans may allow a user to only associate a limited number of mobile devices with the ADP and then set limits on how much data is consumed by each associated mobile device from the ADP. For example, in a premium ADP plan, a user may be associated with the ADP; each of the user's mobile devices (smart phone, digital music player, and tablet) may be associated with the ADP. The network server processes the data transfer request of associated content from each of the smart phone, digital music play and tablet from the data transport of the ADP, regardless of how much data is transferred by each device, as long as the total data consumption is within the maximum allowed per the ADP. In another example, in a less premium ADP plan, a user may only be allowed to associate a digital music player with the ADP.

The above discussed association of the user and mobile device may be made via the ODME website by the owner of the ADP and the association may be stored in a server, for example an ODME database server 140 having a processor. An application, which utilizes the ADP to perform functionality of the application is then associated with the ADP (Step 720). The application may be downloaded or may be preloaded on the mobile device when purchased. For example, an eBook application for downloading and viewing eBooks may be associated with the ADP. In other example, the application may be a photo sharing application, which utilizes the ADP to transfer photos stored on the mobile device to a website.

Next, content type is associated with the ADP (Step 730). For example, the content type that is associated with the ADP may be an image file. music file, text file, and/or website, so that when the associated mobile device transfers the associated file type using the associated application, the network server recognizes that the data transport of the associated file should be performed and counted from the data transport of the ADP. In addition or alternatively, the content associated with the ADP may be a specific file format e.g. JPEG, TIFF, BMP, PDF, MPEG, TXT, DOC, html etc. The ADP is associated with a DTB via the ODME website (Step 740) and the association in stored in a server, such as the ODME database server 140.

When content is transferred uploaded or downloaded) in the manner indicated by the ADP via the associated mobile device, using the associated application, the network server, such as the ODME server, determines whether the content type is of the type associated with the ADP (Step 750).

For example, as noted above in reference to FIG. 4, Step 425, the ADP may be associated with a particular newspaper web site. When the user of the ADP attempts to access the newspaper website from the user's associated mobile device using an associated web browsing application, the network recognizes the mobile device, the browser application, and website (content) as being associated with the ADP, and processes the request to access the website according to the rules of the ADP. For instance, the ADP may allow for 15 views of the newspaper website per month.

Multiple different content types may be associated with the ADP. For example, the ADP may be associated with image files and music files. When the user transfers image files or music files using the associated mobile device, using an associated application, the network recognizes the mobile device, the application, the image file and music file as being associated with the ADP, and processes the request to transfer the file according to the rules of the ADP.

If the content type is of the type associated with the ADP, then a counter as stored in the server is adjusted (incremented or decremented). Each time associated content is transferred by the user using any one of the associated devices, the network server determines the size of the transferred content and may adjust the counter.

The counter reflects an aggregate number of transfers of content units according to the type of ADP association (Step 760). As used herein, the term “content unit” means the transfer of one file of the associated content type that satisfies a preset size threshold per the terms/rules of the ADP. As used herein, the term “aggregate” means the sum of all transfers of content units over the period of time of set in ADP (i.e., per day, month, year). For example, if the user is associated with the ADP, the duration component of which is one month, and the user uses multiple associated mobile devices to transfer data, then the counter may reflect an aggregate number of transfers of content units by the user from all devices per month. In another example, if a single mobile device is associated with the ADP. then the counter may reflect an aggregate number of transfers of content units by the single device per month. Furthermore, if multiple different content types are associated with the ADP, for example image files and music files, using multiple associated mobile device. the counter may reflect an aggregate number of transfers of content units by content type per month as well as the total number of content units transferred per month and the remaining number of content units available for each device, for each content type.

The ADP consumption in terms of content consumption is then displayed on the mobile device in the form of a counter via a data consumption monitoring application, (Step 770). This data consumption monitoring application of the ADP may reside on a network server. The application may then be displayed and available for use on the mobile device by the user selecting an icon on the mobile that allows the user to connect to the network server which stores data consumption of the ADP in a database. The processor of network server accesses the database and processes the data consumption of the ADP data according to the programming commands of the data consumption application for display on the mobile device.

For example, the user may click on an icon for a data content consumption application on the mobile device. The mobile device then communicates with the network server to access a network database which stores data consumption. This data consumption information is processed by the processor of the network server according to the commands of the data consumption application programming stored on the network sever. The data consumption application programming commanding the network server to process the content consumption information for display in terms of content type. In addition, the number of remaining content unit transfers available from the ADP may also be displayed on the mobile device using the data consumption application. This display may be instead of or in addition to displaying the consumption in terms of amount of content in terms of size (e.g., in MB).

In step 750, if the content transferred or attempted to be transferred by the associated mobile device is not of the type associated with the ADP, then the counter is not adjusted (incremented or decremented) (Step 780). For example, further to the above newspaper website example. if the website being accessed by the associated mobile device is the associated newspaper website, then the server adjusts the counter to reflect an aggregate number of visits to the newspaper website by the associated device. The aggregate number of visits to the newspaper website is displayed on the mobile device via the associated application as counter in the form of an image or in a mobile message service message or any other display form and may include how many more visits are available per the ADP. However, if a website is accessed by the associated mobile device that is not associated with the ADP, then the data transport of the ADP is not used and the counter is not adjusted.

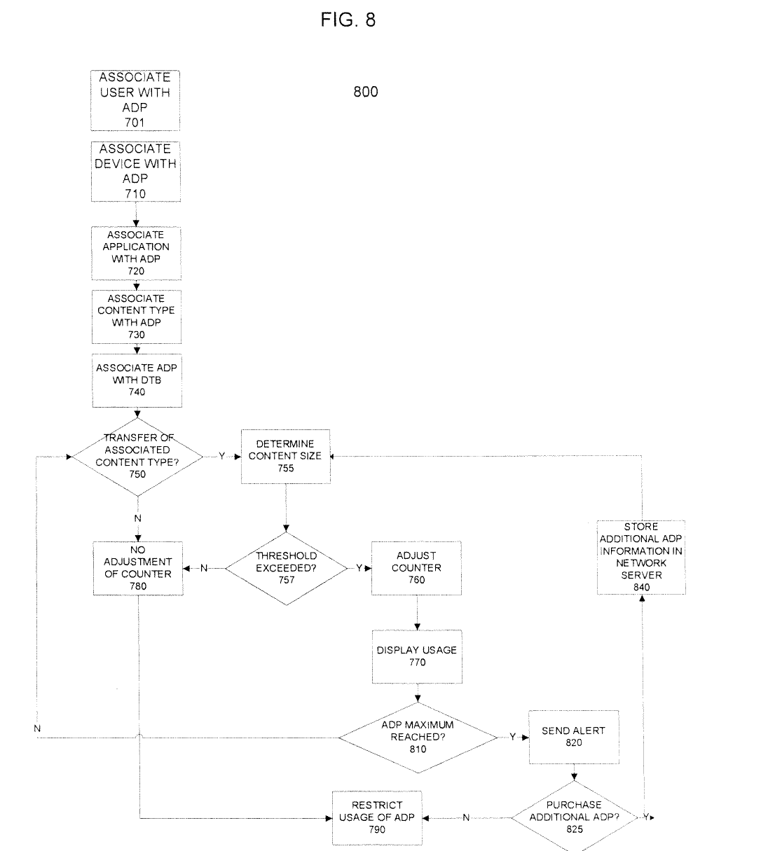

FIG. 8 shows a process 800 in which an ADP is associated with a DTB, mobile device(s), an application, and content type and the number of transfers of associated content type is displayed if the content size exceeds a preset threshold. As in the processes depicted in FIG. 7, the process as shown in FIG. 8 associates a user with an ADP (Step 701), device with the ADP (Step 710), associates an application with the ADP (Step 720), associates content type with the ADP (730) and associates a DTB with the ADP (Step 740). When content is attempted to be transferred via the associated mobile device, the network server, such as the ODME server, determines whether the content type is of the type associated with the ADP (Step 750). If the content is not of the type associated with the ADP, then transfer of this data may be restricted (Step 790). In such a case, the network may send a network communication to the mobile device that the content attempting to be transferred in not associated with an ADP and therefore inform the user that the data transfer to confirm data transfer of the content to proceed under the terms of the user's network data plan. Alternatively, if the user does not have a network data plan in addition to the ADP, the network communication may comprise a message that the data attempting to be transferred is not associated with an ADP therefore will not be completed.

If the server determines that the content transferred by the associated mobile device is of the type associated with the ADP, the server determines the size in megabytes of the transferred associated content (Step 755). The server determines if the size in megabytes of the transferred associated content exceeds a preset threshold amount for the associated content (Step 757), divides the size in megabytes of the transferred associated content by the threshold amount and adjust the counter (Step 760) by the result. Different associated content types per ADP may have the same or different thresholds. The preset threshold is stored in the server. Using this preset value, the owner of the ADP may configure how content will be counted.

For example, the ADP may not count content usage until the full threshold amount is reached. In this example, the threshold for all image files may be 1 MB. If the transferred image file is less than 1 MB, then the counter may not increment the counter. If the transferred image file is greater than 1 MB, then the counter will increment, and the MB amount of the transferred image file that exceeds 1 MB is stored and added to any subsequent transfer. For example, if the threshold for an image file is set at 1 MB and a user transfers one image file having a size of 1.2 MB, then the counter as shown on the application will show 1 image transferred. If the user then transfers another image that is 0.5 MB in size, then the counter will still only show 1 image transfer. If the user then transfers a third image having a file size of 1.6 MB then the counter will show 3 images transferred as the total transfer exceeds 3 MB. Alternatively, the owner of the ADP may decide that only data files that are less than or equal to the threshold amount are automatically transferred at one time and a network communication is sent to the mobile stating that the file is too large if the content file is over the threshold amount.

In addition, based on the rules of the ADP—how much data in MB is permitted per user per period of time (day/month/year), the processor of the application may send instructions to the server processor to calculate how many more file transfers are allowed.

### EXAMPLE 1

ADP allows 500 MB data to be transported per user per month, according to the following rules:

Amount of data transport allowed for tablet device: 400 MB

Amount of data transport allowed for mobile phone: 100 MB

Threshold per image file: 5 MB

Threshold per music file: 1 MB

In this example, an image 10.5 MB in size and a music file 1.1 MB in size are transferred by the tablet, and a music file that is 1.5 MB in size is transferred by the mobile phone, the following counters are displayed following transfer of all three files:
Counter on tablet: 2 images transferred by device; 2 images transferred by user
1 songs transferred by device; 2 songs transferred by user
388.4 MB remaining on device
Counter on phone: 0 images transferred by device; 2 images transferred by user
1 song transferred by device; 2 songs transferred by user
98.5 MB remaining on device

### EXAMPLE 2

ADP allows 500 MB data to be transported per user per month, regardless of which associated mobile device is used, according to the following rules:

Threshold per image file: 5 MB

In this example, an image 11 MB in size is transferred by the tablet, and an image that is 7 MB in size is transferred by the mobile phone, the following counters are displayed following transfer of all two files:
Counter on tablet: 2 images transferred by device; 3 images transferred by user
96 images or 482 MB remaining
Counter on phone: 1 image transferred by device; 3 images transferred by user
96 images or 482 MB remaining

In another example, image files and music files may be associated with the ADP, with image files having a threshold of 1 MB and music files having a threshold of 0.5 MB. If the mobile device transfers an image file of 1.5 MB and a music file of 0.9 MB the counter for image files will increment and display the counter for music files will not increment. However, if under the rules of the ADP, the threshold for any associated content is 1 MB, then in this example, then the counter will increment and display a counter of 2 files transferred.

In another example, users may be prompted by a network communication from the network server to confirm any data transfer prior to the server processing the request. The user may abort the request at this time and the counter will not be adjusted.

In addition, the network server processor may determine if the counter is equal to or exceeds a preset maximum per the rules of the ADP (Step 810). For example a maximum of 50 image files per month, with each image file having a preset threshold of 10 MB. If the counter is equal to or exceeds the preset maximum per the rules of the ADP then an network communication from the server in the form of an alert may be sent to the associated mobile device (Step 820) informing the user that maximum content use according to the rules of the ADP has been reached. The alert may include an offer to the user to purchase an additional or supplemental ADP (Step 825). If the user does purchase an additional or supplemental ADP, then this information is stored in the network server (Step 840) and the counter is adjusted to reflect the remaining number of transfers available based on the additional ADP purchased and may display a rolling counter which includes the date the original ADP was filled and the amount of content transferred since that date. If the user does not purchase any additional or supplemental ADP, then future transfer or access of the associated content type may be restricted by the network (Step 790). If the content is restricted, any future attempts to transfer or access associated content may fail and an alert may be displayed on the mobile device(s) informing the user of the failure and may provide the reason for the failure.

### Examples/Applications

A photo sharing website would like to offer an ADP for users to transfer pictures to its website for a cost of $5 a month for transferring 25 pictures per month. The website purchases a DTB using the ODME as described above and then creates an ADP by naming it. Users of the website submit identifying information of their mobile device(s), such as the mobile device(s) phone number to the photo sharing website, which in turn submits this information to the ODME server via the ODME web site to associate the mobile device(s) with the ADP. The website then associates all image file types, such as JPEG, PNG, TIFF, GIF, BMP, PDF, PSD, MOV, and EPs that are uploaded to its website with the ADP via the ODME website. The association is stored in the ODME server and the ADP is associated with the purchased DTB. The photo sharing website designates a threshold amount for each image file as being 1 MB. When the user of the associated mobile device(s) uploads any file using the mobile device(s), the ODME server determines if the file is an image file and if the image file is being uploaded to the photo sharing website. If the file being uploaded is an image file and the image file is being uploaded to the photo sharing website associated with the ADP, then the ODME determines the size of the image file. If the size in MB of the image is above threshold amount, the size in MB is divided by the threshold amount and the counter is incremented by the result. The application causes the counter to be displayed on the mobile device(s) to show content usage in terms of images uploaded. When the maximum number of images per the ADP has been reached i.e. 25 pictures a month, then the application displays a message on the mobile device(s) alerting the user that no more images can be uploaded on the ADP plan and provides the user with the option to purchase an additional ADP.

In the above example, where the threshold size for one image is 1 MB and user uploads a first image of 1.1 MB, a second image of 0.5 MB and a third image of 0.4 MB the photo sharing website determine that the ADP should increment a counter value 2 images.

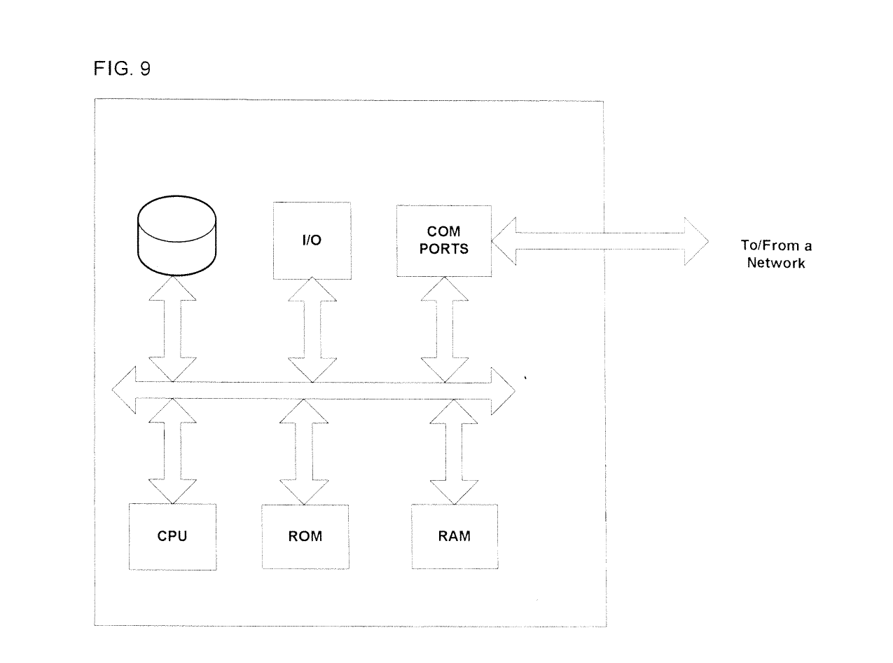

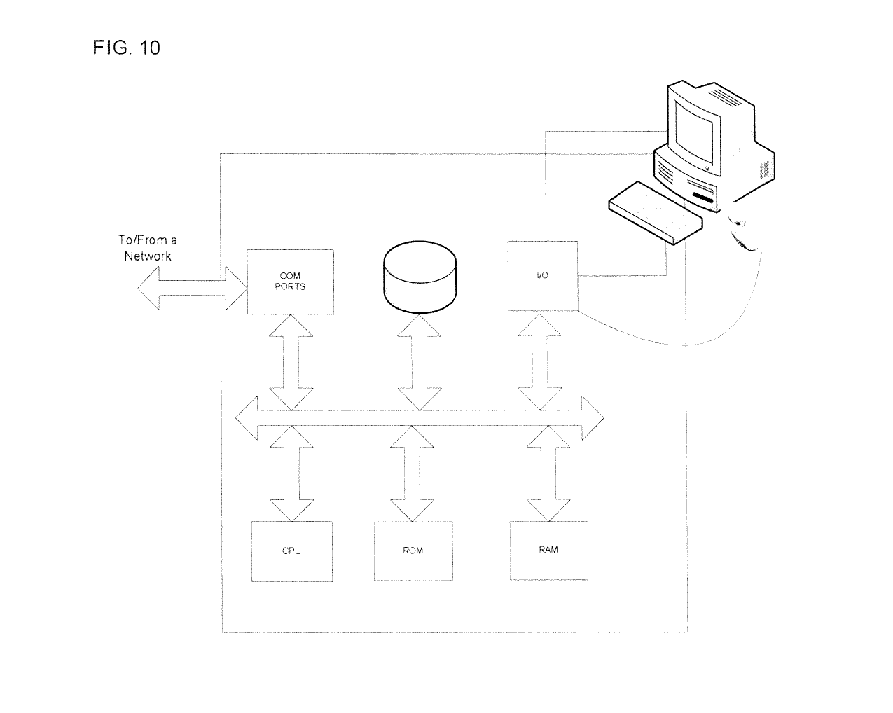

FIGS. 9 and 10 provide functional block diagram illustrations of general purpose computer hardware platforms. FIG. 9 illustrates a network or host computer platform, as may typically be used to implement a server like the ODME web site host server 130 or the ODME database server 140. FIG. 10 depicts a computer with user interface elements, as may be used to implement a personal computer or other type of work station or terminal device. although the computer of FIG. 10 may also act as a server if appropriately programmed. It is believed that those skilled in the art are familiar with the structure, programming and general operation of such computer equipment and as a result the drawings should be self-explanatory.

A platform for a server or the like, for example, includes a data communication interface for packet data communication. The platform also includes a central processing unit (CPU), in the form of one or more processors, for executing program instructions. The platform typically includes an internal communication bus, program storage and data storage for various data files to be processed and/or communicated by the platform, although the server often receives programming and data via network communications. The hardware elements, operating systems and programming languages of such equipment are conventional in nature, and it is presumed that those skilled in the art are adequately familiar therewith. Of course, the various ODME server functions may be implemented in a distributed fashion on a number of similar platforms, to distribute the processing load. Alternatively, the servers 130 and 140 may be implemented by appropriate programming of one computer hardware platform.

Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device(s). Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the server(s) of the ODME type exchange. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions. cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions, The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising the steps of:
associating an alternative data plan (ADP) with a data transport bundle (DTB) for mobile data transport through a network, the ADP having been configured for a service via a data market exchange of sufficient size to provide at least the amount of data transport required by the ADP;
associating a mobile device, an application accessed by the mobile device, and a content type with the ADP; wherein the application utilizes data transport through the network under the ADP to perform functionality of the application;
determining if content being transferred by the associated mobile device is of the associated content type;
only when it is determined that content being transferred is of the associated content type:
determining whether an amount of the content being transferred has reached a preset threshold:
if so, changing a counter reflecting an aggregate number of content units transferred by the associated mobile device utilizing the ADP;
if not, not changing the counter; and
determining the aggregate number of content units transferred by the mobile device and displaying the aggregate number of content units transferred by the mobile device as an indication of the usage by the mobile device of the ADP based on content consumption instead of or in addition to megabyte consumption.

2. The method of claim 1, further comprising the step of associating the ADP with a transfer of content to and from a website.

3. The method of claim 1, wherein multiple different content types are associated with the ADP.

4. The method of claim 3. wherein the preset threshold defining each content unit is the same for each type of content.

5. The method of claim 3. wherein the preset threshold defining each content unit is different for at least two different types of content.

6. The method of claim 5. wherein the aggregate number of content units transferred by the mobile device for each different content type is displayed on the mobile device.

7. The method of claim 1. wherein the ADP comprises an amount of data transport over a time duration.

8. The method of claim 7, further comprising the step of sending a network communication to the mobile device when the amount of data transport over the time duration of the ADP is reached.

9. The method of claim 8, wherein the network communication comprises the option of purchasing an additional ADP.

10. The method of claim 9, further comprising the step of restricting data transport by the associated mobile device when the amount of data transport over the time duration of the ADP is reached and additional ADP has not been purchased.

11. The method of claim 9, wherein the counter is changed based on any additional ADP purchased.

12. A method comprising the steps of:
associating an alternative data plan (ADP) with a data transport bundle (DTB) for mobile data transport through a network, the ADP having been configured for a service via a data market exchange of sufficient size to provide at least the amount of data transport required by the ADP;
associating a mobile device, an application accessed by the mobile device, and a content type with the ADP; wherein the application utilizes data transport through the network under the ADP to perform functionality of the application;
determining if content being transferred by the associated mobile device is of the associated content type;
only when it is determined that content being transferred is of the associated content type:
changing a counter reflecting an aggregate number of content units transferred by he associated mobile device utilizing the ADP; and
determining the aggregate number of content units transferred by the mobile device and displaying the aggregate number of content units transferred by the mobile device as an indication of the usage by the mobile device of the ADP based on content consumption instead of or in addition to megabyte consumption.

13. The method of claim 12, further comprising the step of associating the ADP with a transfer of content to and from a website.

14. The method of claim 12. further comprising the step of providing a network communication to the mobile device prior to transferring data.

15. The method of claim 14, further comprising a step of providing a network communication from the network to the mobile device to abort the data transfer prior to processing of the data transfer.

16. The method of claim 15, wherein the counter is not incremented when data transfer is aborted.

17. The method of claim 12, further comprising the step of sending a network communication to the mobile device when the amount of data transport over a time duration of the ADP is reached.

18. The method of claim 17, wherein the network communication comprises the option of purchasing an additional ADP.

19. The method of claim 18, further comprising the step of restricting data transport by the associated mobile device when the amount of data transport over the time duration of the ADP is reached and additional ADP has not been purchased.

20. The method of claim 12, wherein multiple different content types are associated with the ADP.
